(19) United States
(12) Patent Application Publication
(10) Pub. No.: US 2005/0189764 A1
(43) Pub. Date: Sep. 1, 2005

(54) Connector assembly

(76) Inventor: Takashi Ono, Inuyama (JP)

Correspondence Address: Takashi Ono, 36-14 Goromaru, Inuyama Shi, Aitiken, JP

(21) Appl. No.: 10/274,705

(22) Filed: Oct. 18, 2002

(51) Int. Cl. F16L 37/00

(52) U.S. Cl. 285/305

(57) ABSTRACT

A connector assembly includes a mating male and female element and further includes a retainer made from large high friction material, a generally annular sealing element and an anti-rotation mechanism for restraining the relative rotation between the male element and female element. The female element includes a housing formed with an axial bore for receive an insert end portion of the male element at a receipt end portion, the receipt end portion having an enlarged diameter internal bore potion adapt to receive the retainer fore locking a radially enlarged annular projection on the insert end portion of the male element, which is secured the receipt end portion of the female element.

### BACKGROUND OF THE INVENTION

1. Field of Invention

The present invention relates to a connector assembly, more particularly, to a connector assembly providing with a means for restraining relative rotation between a male element and a female element by an intervention of a large high friction element.

2. Description of the Prior Art

There are many previously known quick connector assembly which are typically includes a tubular female element, a male element and many type of retainer elements for securing the male element within the female element. More particularly, the tubular female element adapted for selective locking connect engagement with a tubular male element. The tubular male element typically includes a insert end portion terminating in a tip end and having a radially extending annular projection spaced from the tip end.

The tubular female element formed with an axially extending stepped bore for receive the male element at the receipt end portion being open at the first end and for providing a fluid path at an other end potion open at a second end. The receipt end portion has an enlarged diameter internal bore potion adapt to axially receive the insert end portion of the male element, the enlarged diameter internal bore potion having an axial length sufficient to receive the annular projection on the male element within the enlarged diameter internal bore potion.

Generally, annular sealing element disposed within the axial stepped bore for providing fluid tight seal between confronting portion of the tubular male element and the tubular female element. All of said many type retainer elements are securely provided with receipt end portion of the female element and they includes a deformable portion and a lock portion provided with the deformable portion for locking the male element and the female element together. That is to say, lock portion engage the annular projection operative to corn from the flexible deformation of the deformable portion when the annular projection on the insert end portion is fully inserted into the receipt end portion of the female element. Therefore the male and female element is tight sealinglly and rotatably (swivelably) connected each other when the male element was fully inserted into receipt end portion of the tubular female element.

Those connector assemblies are well known. Examples of such assemblies are disclosed in U.S. Pat. No. 4,601,497, to Bartholomew, U.S. Pat. No. 5,730,4 to Szabo etc, U.S. Pat. No. 5,772,263 to Lewis etc. U.S. Pat. No. 5,988,705 to Norkey etc. U.S. Pat. No. 5,634,673 to Miyazaki etc.

Those connector assemblies have been found to be useful in a wide range of application. In particular they are frequently employed for joining fluid carrying conduits in automotive vehicle and industrial applications.

However, all known embodiments intend to provide an easily connectable assembly, which is inexpensive to manufacture and entail simple designs, there is no means for restraining a rotational movement between the male and female element in the circumferential direction, so that relative rotation between the male and female element can occur by shocks and vibration on the automotive vehicle, whereby it produces unexpected wear of the annular sealing element and there is inclined to leak at a connecting position, there is also inclined to leak at a connecting position by the relative rotation between the male and female element, as the annular sealing element is inclined to harden at an atmosphere of low temperature such as lower than −5° C., even if the annular sealing element was not wear out. Further those known connector assemblys are failure to insure the complete connection, for example, in applications where hazardous material is to flow through connecting, prevention of inadvertent release is of primary concern. Accordingly, relatively high axial pull-apart strength specifications are mandated. Furthermore, there is at the receipt end portion of the female element a relative wide gap, through which dust and dirt can penetrate into the push-in space between receipt end portion and insert end portion when the male element was fully inserted into the receipt end portion of the female element. Yet furthermore for the fitter of such a quick-action connecting it is not easy to tell whether correctly connected position has been reached after introducing the insert end portion into receipt end portion.

Accordingly, it is the primary object of the present invention to provide a connector assembly having a means for restraining relative rotation between a male element and a female element, which can be restrain the relative rotation at same time or after rotatably connected each other.

Another objection of the present invention is to provide a connector assembly can improve the axial pull-apart strength than those of a known connector assembly. Yet another objection of the present invention is to provide a dust-protection connector assembly which can be preventing the penetration of dust and dirt into the push-in space between receipt end portion and insert end portion. In preferable embodiments also can prevent a function of the indicator.

### SUMMARY OF THE PRESENT INVENTION

The present invention is based on the idea of restraining relative rotation between a male element and a female element by an intervention of a large high friction element between a male element and a fastener element.

To achieve the foregoing object, the present invention provides a connector assembly which generally comprises an elongated tubular male element, a mating tubular female element, retainer means for locking the male element and female element and a generally annular sealing element.

The connector assembly furthermore comprises the large high friction element, fastening means for fastening the large high friction element against the male element which is fully inserted into the female element and an aperture serve for a fastening operation of the fastener means, which is formed with a housing of the female element and means for preventing a rotational movement between the fastening means and the female element for restraining the relative rotation between the male element and female element.

The male element includes an insert end portion formed with a smooth cylindlical exterior surface and a radially enlarged annular projection on the insert end portion, spaced from the tip end.

The female element includes a housing formed with an axial bore for receive the insert end portion of the male element at a receipt end portion. The receipt end portion includes an enlarged diameter internal bore potion adapted to axially receive the insert end portion of the male element. The enlarged diameter internal bore potion has an axial length sufficient to receive the annular projection on the male element and the large high friction element within the enlarged diameter internal bore potion.

The retainer means is securely provided with at the receipt end portion of the female element.

The generally annular sealing element disposed within the axial bore for providing a fluid tight seal between confronting portions of the tubular male element and the tubular female element.

The aperture defining a sidewall formed in the housing a in transverse communication with the enlarged diameter internal bore potion.

The fastener means, so movably mounted in the receipt end portion of the female element as to be substantially diametrically, symmetrically able to dispose the outside of the large high friction means for fastening the large high friction means against the insert end portion which is fully inserted into the receive end portion of the female element, in operative relation to a fastening operation, the fastener means comprising a unitary, spring one piece body, the spring one piece body has a pair of substantially, opposite free end sections within the enlarged diameter internal bore potion to permit a substantially radial movement of the body for fastening the large high friction means with a fastening operation, the pair of free end section including at least one free end section having a terminal end portion which is substantially, transversely passed through the aperture from the enlarged diameter internal bore potion to an outside of the receipt end portion.

The high friction means disposed circumference direction for being produced the torque resistance which is produced when the large high friction means is fsstened against the insert end portion by the fastener means.

The means for preventing a rotational movement between the fastening means and the female element, the means including at least one of the aperture having an engaging sidewall in the sidewall defining the one of the aperture engage the terminal end portion when the fastener means fastens the large high friction means against the insert end portion.

In the first embodiment, the retainer element may be made from any large high frictional materials, such as rubber or ethylene-vinyl acetate copolymer, which is in the form of a unitary, generally cylindrically C-shaped resilient one piece body. Such Generally C-shaped retainer providing a large high friction element is detachably secured the receipt end portion of male element.

As a first embodiment of a other preferably generally C-shaped retainer, a gain generally C-shaped retainer composed of two layer which was formed integral with a C-shaped inner layer and U-shaped a thin outer layer. The C-shaped inner layer 321a is made from large high frictional material, such as rubbers to produce the high torque resistance. On the other hand, generally U-shaped thin outer layer 321b made from small low frictional material, such as Nylon 11.

Above all generally C-shaped retainers include a generally cylindrically C-shaped shaped deformale one piece body includes the first and second end portions at an axially both ends thereof. The first end portion having a tapered inner peripheral surface a being reduced diametrically toward the second perpendicular end side and the second end portion having an annular stepped recess formed as substantially C shaped in cross section as one portion of an inner peripheral portion of the body. Accordingly, annular stepped recess constitute the lock portion to engage the annular projection when the insert end portion is fully inserted into the receipt end portion of the female element. Whereby, the male element 10 is rotatably (swivelably) connected to the female element easily.

Usually, plural annular sealing elements are disposed within the axial bore for providing a fluid tight seal between confronting portions of the tubular male element and the tubular female element.

A fastener means is can forcibly inserted into the fastened position for fastening the large high friction element against the insert end portion the male element was fully inserted into the elongated tubular female element.

In the first and second embodiment, the fasten element is made from any suitable material, such as thin walled metal plate or plastic, which is in the form of a unitary, generally U-shaped spring one piece body. Such U-shaped spring clip includes a cross member and first and second legs spaced apart and extending generally in parallel from the cross member. Two legs of the U-shaped spring clip can be slidably, transversely inserted into fasten position along the aperture. Preferably, two legs respectively formed with substantially, opposite free end section to permit a substantially radial movement of the body for fastening the large high friction element with a fastening operation.

According to the second embodiment, two legs are substantially diametrically, symmetrically and are spaced apart extending generally in parallel from the cross member. Preferably, each free end sections of two legs are initially slidably mounted a coming apertures by engagement with the coming apertures in the open position. Each free end sections are respectively formed with a terminal end portions which are substantially, transversely passed through going apertures from the enlarged diameter internal bore potion to an outside of the receipt end portion for fastening the large high friction element by operating pushing the U-shaped spring clip. In this case the large high friction element is forcibly fastened by a V-shaped internal wedge which is constituted a pair of sidewalls of the aperture defining a sidewalls.

It is obvious that the relative rotation between the spring clip and the female element is prevented when the is in the fastening position. On the other hand, the relative rotation between the male element and the spring clip is restrained by the torque resistance which is produced when the large high friction element is fastened against the insert end portion by spring clip. Therefore, the relative rotation between the male element and the female element is restrained.

In addition, according to an other embodiment similar to the second embodiment, if a U-shaped spring clip is designed a inner diameter of a large high friction element is smaller than a outer diameter of the insert end portion when a large high friction element is fastened against the insert end portion. It is possible to resiliently fasten the large high friction element.

According to the second embodiment, the large high friction means serve for a retainer element when the large high friction element is fastened against the insert end portion.

An other connector assembly of the present invention similar to the second embodiment can compose by separating a large high friction element from a U-shaped spring clip.

Further, an other connector assembly of the present invention similar to the second embodiment can compose by forming integral with a large high friction element on an outer peripheral surface of the insert end portion of the male element.

Furthermore, according to an other connector assembly of the present invention similar to the second embodiment, a large high friction means can be compose by forming an indent at an inside surfaces on the both opposite free end sections of two legs and/or an outer peripheral surface of the insert end portion of the male element.

According to the first embodiment, above all retainers made from a large high frictional material, so that those retainers serve for a large high friction element at the same time. Substantially, outer diameter of the retainer is slightly greater than inner diameter of the clip.

Also, according to the first embodiment, U-shaped spring clip includes the first and second legs. Each legs respectively formed with substantially, opposite free end section to permit a substantially radial movement of the body for resiliently fastening the retainer element with a fastening operation. Two legs of the U-shaped spring clip can be slidably, transversely inserted into fasten position along a relatively large coming aperture. Preferably, each free end sections of two legs are initially slidably mounted a relatively large coming aperture by engagement with the coming apertures in the open position. But, the first leg is longer than the second leg. The first free end sections of the first leg is formed with a wave shaped engaging projection portion outwardly projected at a terminal end potion adjacent to terminal end thereof as an engaging terminal end portion, which is substantially, transversely passed through poky going apertures from the enlarged diameter internal bore potion to an outside of the receipt end portion for fastening the retainer element and for securing to the female element by operating pushing the U-shaped spring clip. On the other hand, The second free end sections of the second leg is inserted into the enlarged diameter internal bore potion to permit a substantially radial movement of the body for fastening the retainer element within the enlarged diameter internal bore portion.

Therefore, it is obvious that the relative rotation between the spring clip and the female element is prevented when the U-shaped spring clip is in the fastening position. On the other hand, the relative rotation between the male element and the spring clip is restrained by the torque resistance which is produced when the retainer is fastened against the insert end portion by spring clip. Therefore, the relative rotation between the male element and the female element is restrained.

According to the first and second embodiment of the connector assembly, a large high friction element is tightly fastened against hinder area of the insert end portion which elongated from the back surface of the annular projection by fastener means, so that an axial pull-apart strength is added.

Also according to the first embodiment, preferably the C-shaped retainer is so fastened by the U-shaped spring clip after the male element is connected to the female element by the retainer that an axial pull-apart strength is added.

Also according to a desirable another modification of a C-shaped retainer (not shown), it is possible to close perfectly a space between the separating both ends of the resilient C-shaped retainer when the U-shaped spring clip is forcibly moved from the open position to the fastened position.

Therefore, devised the C-shaped retainer can protect the dust penetrating into push-in space between the insert end portion and receipt end portion in the connected portion.

In addition, according to the first and second embodiment of the connector assembly, the U-shaped spring clip not only can function as fastener means but also can function visual indicator device for indicating the male element and female element are completely connected each other.

According to third embodiment, the retainer element can comprise a ring-shaped spring clip.

According to third embodiment, the a large high friction element can form a cylindrical body.

### BREF DESCRIPTION OF THE DRAWING

The various features, advantages and other uses of the present will become more apparent by referring to the following detailed description and drawing in which:

FIG. 1 is an exploded perspective view of the connector assembly of a first embodiment of the present invention;

FIG. 2 is a partly longitudinal section view of a first embodiment of the connector assembly according to a present invention having a male element, a disconnected female element with a C-shaped retainer and a U-shaped spring clip receiving the receipt end portion and showing the spring clip in the unfastened position;

FIG. 3 is a side view of the C-shaped retainer utilized in the embodiment of FIG. 1, showing in section view;

FIG. 4 is a plan view of FIG. 3;

FIG. 5 is a view as seen from the line 3 III-III of FIG. 2;

FIG. 6 is a partially longitudinal section view similar to that of FIG. 2 but showing the male element is partially inserted into female element;

FIG. 7 is a view as seen from the line IV-IV of FIG. 6;

FIG. 8 is a longitudinal section view similar to that of FIG. 2 but showing the U-shaped spring clip in the open position and the rotatably locked state of the male element and female element;

FIG. 9 is a view as seen from the line V-V of FIG. 8;

FIG. 10 is a cross-section view similar to that of FIG. 9 but showing the U-shaped spring clip in the fastening position and the un-rotatably locked state of the male element and female element;

FIG. 11 is a side view of a modification of the C-shaped retainer utilized in the embodiment of FIG. 1, showing in section view;

FIG. 12 is a front elevation view of FIG. 11; FIG. 3 is a side view of the C-shaped retainer utilized in the embodiment of FIG. 1, showing in section view;

FIG. 13 is a cross section view of FIG. 11;

FIG. 14 is a partly longitudinal section view of a second embodiment of the connector assembly according to a present invention having a male element, a disconnected female element taken at the a fastener device receiving apertures and showing the fastener device in the unfastened position;

FIG. 15 is a longitudinal section view similar to that of FIG. 14 but showing a U-shaped fastener device in the fastened position and the un-rotatably locked state of the male element and female element;

FIG. 16 is a front elevation view of a U-shaped fastener device utilized in the embodiment of FIG. 14;

FIG. 17 is a view as seen from the line VI-VI of FIG. 14;

FIG. 18 is a view as seen from the line VII-VII of FIG. 15;

FIG. 19 is cross-section view similar to that of FIG. 17 but showing the rotatably locked state of the male element and female element;

FIG. 20 is a similar to that of FIG. 19 but showing the female element taken at the modification of fastener device receiving;

FIG. 21 is a partly broken away longitudinal section view a third embodiment of the connector assembly according to a present invention having a female element comprising of two parts with a cylindrical retainer device, a cylindrical large high friction element and a generally ring-shaped spring clip, and showing the ring-shaped spring clip in an expansion state by U-shaped holder device;

FIG. 22 is a partly broken away longitudinal section view similar to that of FIG. 21 but showing a ring-shaped clip in the fastened state and the un-rotatably locked state of the male element and female element;

FIG. 23 is a view as seen from the line VIII-VIII of FIG. 21;

FIG. 24 is a view as seen from the line IX-IX of FIG. 21;

FIG. 25 is a front elevation view of a female element illustrated in FIG. 21;

FIG. 26 is a view as seen from the line X-X of FIG. 22;

FIG. 27 is a side view of the cylindrical retainer device utilized in the embodiment of FIG. 22, showing in section view;

FIG. 28 is a plan view of FIG. 27;

FIG. 29 is a side view of the cylindrical large high friction element utilized in the embodiment of FIG. 22, showing in section view;

FIG. 30 is an exploded perspective view of the ring-shaped spring clip utilized in the embodiment of FIG. 22 showing in expantion state;

### DETAILD DESCRIPTION OF THE PREFERDED EMBODIMENT

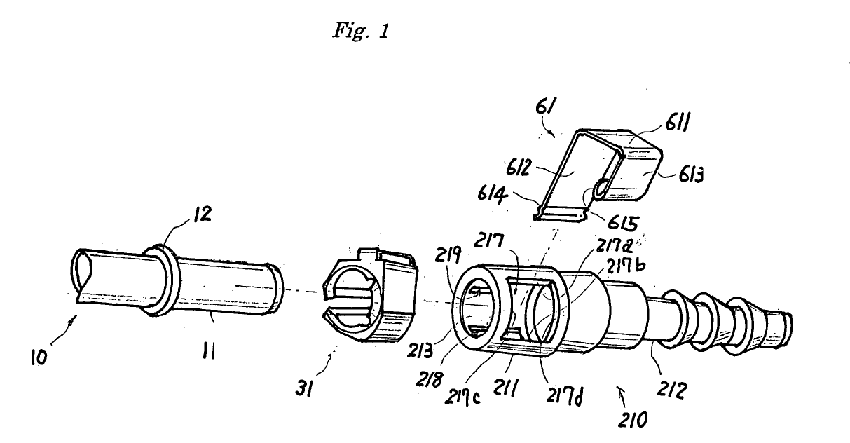

Referring now to FIG. 1-10 in particular, there is depicted first one embodiment of the connector assembly of the present invention. The connector assembly includes an elongated tubular female element 210, a tubular male element 10 adapted to convey fluid, generally C-shaped retainer element 31, generally U-shaped spring clip 61, and three apertures formed with the female element 210. Particularly, generally C-shaped retainer 31 is made of large high friction material, so that this retainer serving for a large high friction element at the same time. As is conventional the tubular male element 10 is in the form a conduit or tube formed by a substantially constant thickness circular wall. In an exemplary application, the conduit 10 includes an axially extending tubular insert end portion 11 terminating in a tip end 11a and an annular projection 12 projecting radially outwardly from the insert end portion 11 having a smooth cylindrical exterior surface. The radially enlarged annular projection 12 is formed with the insert end portion 11 spaced from the tip end 11a, and provides an opposed front and back surfaces 12a and 12b. The axially, smoothly extending insert end portion 11 coaxially includes a front area 13 elongated between the tip end 11a and the front surfaces 12a of the annular projection 12 and a hinder area 14 elongated from the back surface 12b of the annular projection 12 to hinder direction.

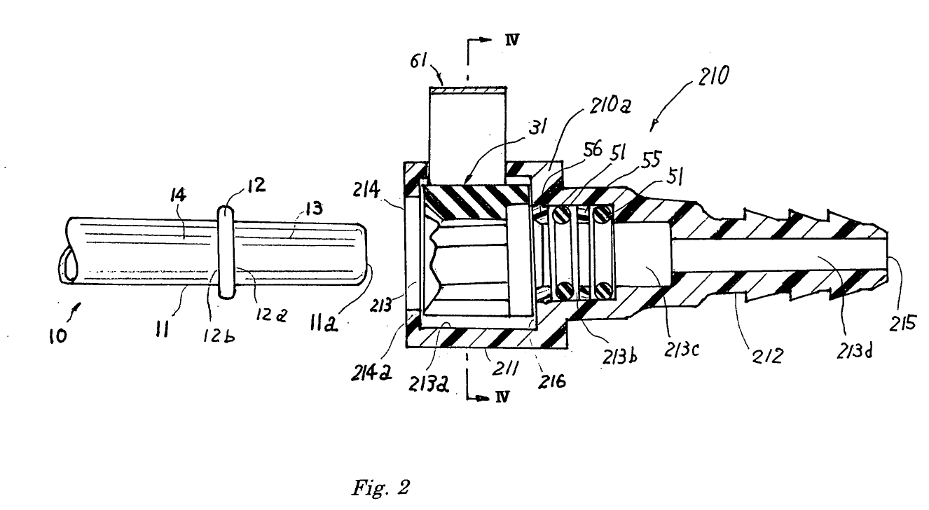

As is typical in the tubular female element 210 may be made from any suitable material, such as plastic or metal and may have any appropriate outer shape, such as cylinder or hex construction. Referring now to the drawing, FIG. 1 and FIG. 2 in particular, tubular female element 210 including a housing 210a formed with a stepped axial bore 213 for receiving the insert end portion 11 of the conduit 10 at an enlarged diameter end portion (receipt end portion) 211. The receipt end portion 211is adjacent to an one opening 214.

Stepped axial bore 213 extending there from the receipt end portion 211 to an other end portion 212.

The receipt end portion 211 is formed with most enlarged first diameter internal bore portion 213a, the second internal bore portion 213b and the third internal bore portion 213c respectively extending axially from an annular flange 214a adjacent one open end 214, which adapt to receive the insert end portion 11. More particularly, the stepped bore 213 includes the first diameter internal bore portion 213a extending from the annular flange 214a adjacent to one open end 214 to the smaller diameter and the second enlarged diameter internal bore portion 213b extending axially from one end of the first diameter internal bore portion 213a. A third yet smaller diameter third bore portion 213c axially extending from one end of the second bore portion 213b and communicates to a still smaller fourth bore portion 213d which extends to an other open end 215 of the female element 210.

In addition, a radially inwardly extending annular surface 216 is formed between the first enlarged diameter internal bore portion 211a and the second enlarged diameter internal bore portion 213b for limiting an axially inwardly movement of the male element 10. The first enlarged diameter internal bore portion 213a having an axial length sufficient to receive the receipt end portion 11 as well as annular projection 12 of the male element 210.

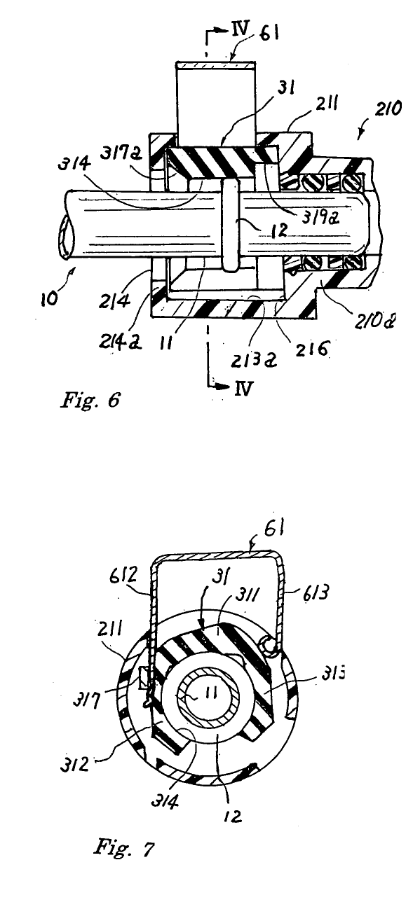

And the Generally C-shaped retainer element 31 as best shown in FIG. 6 of the drawing.

Referring to FIG. 1-5, three apertures 217,218 and 219 are formed with the receipt end portion 211 communicate with the first bore portion 213a transversely cylindrical wall of the receipt end portion 211 respectively, which are respectively defined a plural sidewalls.

A relatively large coming aperture 217, a relatively small aperture 218 and a poky going aperture 219 are circumferentially arranged offset with the respect to each other by obtuse angle on the same circle of an annular wall of the receipt end portion 211.

The relatively large coming aperture 217 is defined a pair of opposed axially extending parallel sidewalls 217a, 217b and a pair of opposed acuate shaped parallel sidewalls 211c and 211d. The pair of opposed axially extending parallel sidewalls 217a, 217b are peripherally spaced apart a predetermined distance which is slightly greater than depth of the U-shaped spring clip 61, also the pair of opposed acuate shaped parallel sidewalls 211c and 211d are axially spaced apart a predetermined distance which is slightly greater than width of the U-shaped spring clip 61.

As is typical in connector assembly, two O-rings 51 and 51 and an interposed spacer 55 and top bushing member 56 are mounted within the second bore portion 213b as shown in FIG. 2. O-ring 51 is preferably formed from an elastomeric material such as rubber. The bushing member 56 is made from plastic and metallic material.

Generally C-shaped retainer 31 may be made from any large high frictional materials, such as rubber or ethylene-vinyl acetate copolymer, so that retainer 31 serve for a large high friction element at the same time. Retainer is in the form of a unitary, generally C-shaped cylindrically shaped resilient one piece body formed as substantially C-shaped in cross section with a space between the separating both ends thereof, so that C-shaped retainer element 31 permits radial deformation or radial flexible compression of the body. Therefore, the retainer 31 can be secured the first enlarged diameter internal bore portion 213a which is formed between the annular flange 214a and the annular surface 216 by being axially passed through the annular flange 214a of the female element 210 as best shown in FIG. 2. of the drawing. The result, the retainer 31 can be detachably secured into the receipt end portion 211.

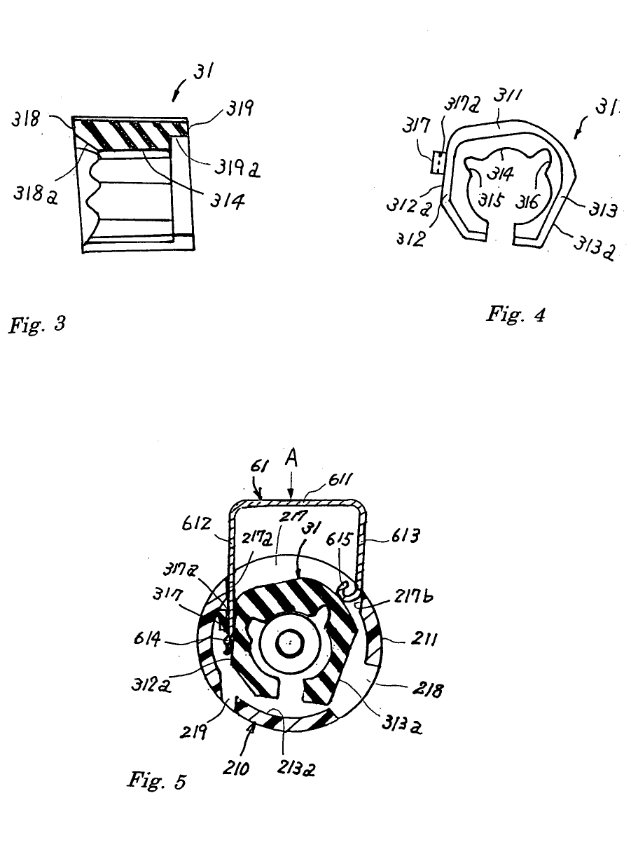

It can be seen from FIG. 1, FIG. 3 and FIG. 4 that generally C-shaped retainer 31, generally cylindrically shaped resilient body formed as substantially C shaped in cross section, includes a rectangular base 311 and two side legs 312 and 313 of an approximately equal lengths. The retainer 31 further includes an axially extending, substantially circumferential inner surface 314 having inner diameter equal to outer diameter of the insert end portion 11, concentric with a center axis thereof. Also, circumferential inner surface 314 includes a pair of acuate shaped recesses 315 and 316 formed with the both inner corner portions positioning the jointed two side legs 312 and 313 to the rectangular base 311. Two side legs 312 and 313 are respectively provided with opposed parallel flat exterior surfaces 312a, and 313a extending from exterior surface 311a of the rectangular base 311, and that one of side leg 312 provided with a projection potion 317 projecting from the flat exterior surface 312a thereof. And projection potion 317 has a thorough hole 317a along the flat exterior surface 312a.

In addition, the retainer 31 further includes the first and second end portions 318, 319 at an axially both ends thereof. The first end portion 318 having a tapered inner peripheral surface 318a being reduced diametrically toward the second end side while the second end portion 319 having a stepped annular recess 319a thereof. And, a circumferential inner surface 314 extends between tapered inner peripheral surface 318a and stepped annular recess 319a paralleled to the center axis.

It can be seen from FIG. 2 and FIG. 5 that C-shaped retainer 31 is previously, axially inserting into the first diameter internal bore portion 213a in the receipt end portion 211 after two O-rings 51 and 51, an interposed spacer 55 and a top bushing member 56 war respectively mounted within the second bore portion 213b. Next, U-shaped spring clip 61 is transversely, movably mounted in the receipt end portion 211 of the female element 210 via the relatively large coming aperture 217.

As best shown in FIG. 1 of the drawing, U-shaped spring clip 61 is in the form of a unitary, spring one piece body formed as generally U or C-shaped in cross section which is made from any suitable material, such as plastic or thin walled metal plate. U-shaped spring clip 61 includes a cross member 611 and two legs 612, 613 spaced apart and extending generally in parallel from the cross member 611. In addition, opposed two legs 612, 613 can respectively obliquely deform to permit radial movement of a terminal end thereof as described hereafter. The first leg 612 is longer than the second leg 613, and first leg 612 is formed with a wave shaped engaging projection portion 614 outwardly projected at a terminal end potion adjacent to terminal end thereof as an engaging terminal end portion.

On the other hand, second leg 613 formed with a relatively large rolled engaging projection portion 615 inwardly projected at a terminal end potion. Therefore, U-shaped spring clip 61 may be in the form of a unitary, spring one piece body formed as substantially U-shaped in cross section. In addition, generally diameter (or spaced apart distance) of the clip 61 is designed slightly smaller than outer diameter (or width) of the retainer 31.

Also, a pair of opposed parallel flat exterior surface 312a, and 313a of the retainer 31 are previously disposed to arrange parallel to the opposed parallel axially extending sidewalls 217a and 217b defining the large aperture 217 within the first diameter internal bore portion 213a as shown in FIG. 5.

Foregoing relatively large coming aperture 217 allows sliderable insertion of the U-shaped spring clip 61 into the first enlarged diameter internal bore portion 213a. Relatively small aperture 218 circumferentially spaced apart predetermined distance which is smaller than the circumferential length of the large aperture 217. And, the poky going aperture 219 is flush with one sidewall 217a and is formed with the cylindrical wall of the receipt end portion 211 to traverse the first bore portion 213a. Accordingly, when the spring clip 61 initially is in the open position (FIGS. 2 and 5), the first leg 612 of the spring clip 61 can pass through the large aperture 217 along the one sidewall 217a, and that the hole 317a of a projection potion 317 which is formed with the retainer 31 being secured into the first diameter internal bore portion 213a.

Once the wave shaped engaging projection 614 of the first leg 612 pass through the hole 317a, the wave shaped engaging projection portion 614 is engaged the projection potion 317 of the retainer 31 for retaining the spring clip 61 to the receive end portion 211. While the rolled engaging projection portion 615 of the second leg 613 is passably engaged between the other sidewall 217b and the confronting portion of the retainer 31.

It can be seen from FIG. 6 and FIG. 7 that the generally C-shape retainer 31 is mounted to be able to expand in the first bore portion 213a when the U or C-shape clip 61 is in the open position. More particularly, an annular projection 12 on the insert end portion 11 forces against the tapered inner peripheral surface 317a of the retainer 31 when the male element 10 is inserted into female element 210. Accordingly, deformable retainer body portion is so radially expanded easily, that since the retainer 31 allows the annular projection 12 there through along the inner surface 314 after the clip 61 is previously mounted in the open position.

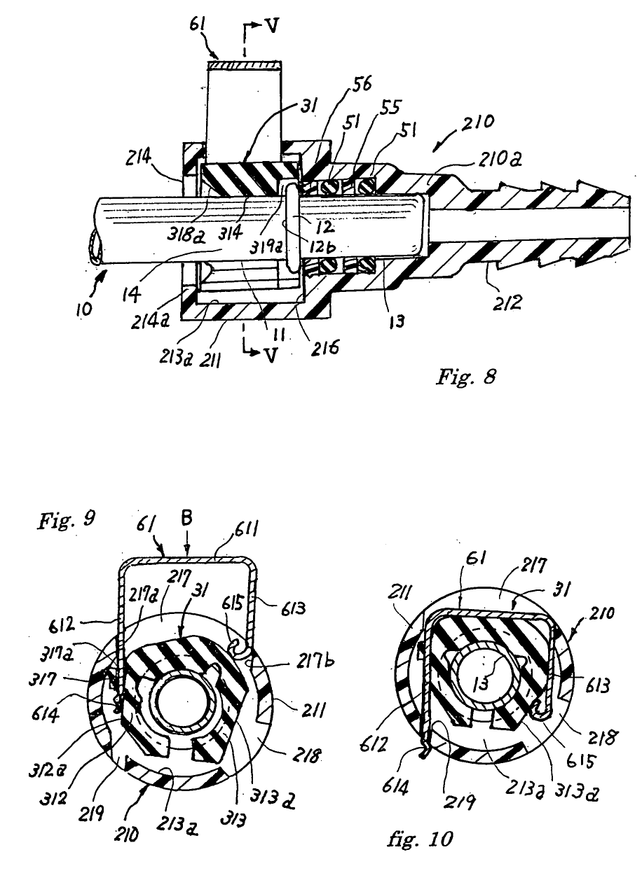

Once the annular projection 12 passes through the inner surface 314, the retainer 31 snap back to engage radial stepped annular engaging means 319a or radial surface portion thereof and the annular projection 12. And then the annular projection 12 snap into the stepped annular recess 319a at the same time, since it permits easy connection and disconnection of the male element 10 and female element 210 as shown in FIG. 8. It will be noted that the male element 10 and the female element 210 only rotatably locked each other.

According to the first embodiment, as the retainer 31 made from large high frictional material, this retainer 31 can function as a large high friction element too when the generally C-shape retainer 31 is fastened against the insert end portion 11 by the U or C-shape clip 61, as describe hereafter. In addition, simultaneously with the insertion of the insert end portion 11 of the conduit 10 into the connected portion of the receipt end portion 211 of the female element 210, O-rings 51 and 51 fluidly sealingly engage an outer periphery of the front area 13 of the insert end portion 11 as best shown in FIG. 8 of the drawing. Thus the O-rings 51 and 51 form a fluid tight seal between the conduit 10 and the female element 210.

Finally, the wave shaped engaging projection portion 614 of the first leg 612 can be passed through the poky going aperture 219 from the enlarged diameter internal bore potion 213a to an outside of the receipt end portion 211 for engaging with the sidewall of the poky going aperture 219 while the rolled engaging projection portion 615 can be inserted into the first diameter internal bore portion 213a by radially pushing the spring clip 61 indicated by arrow B as shown in FIG. 9 after the male element 10 and the female element 210 relatively rotatably locked together as shown in FIG. 10.

Therefore, spring clip 61 is non-rotatably secured against the female element 220 while can resiliently hold an exterior surface of the retainer (large high friction element) 31 for fastening the large high friction element 31 against the insert end portion. That is to say, spring clip 61 can concentricly fasten the large high friction means 31 against the insert end portion 11 of the male element 10 which is fully inserted into the receive end portion 211 of the female element 210 in the fastening position (FIG. 10). Because, an inner diameter (or spaced apart distance) of the clip 61 is designed smaller than outer diameter (or width) of the retainer 31.

Accordingly, U or C-shape spring clip 61 is so movably mounted in the receipt end portion 211 of the female element 210 as to be substantially diametrically, symmetrically able to dispose the outside of the large high friction element (retainer) 31 in operative relation to a fastening operation to fasten the large high friction element 31 against the insert end portion 11 of the male element 10 in order to concentricly fasten the large high friction element 31 against the insert end portion 11 of the male element 10 which is fully inserted into the receive end portion 211 of the female element 210. U or C-shape clip 61 is in the forming of a unitary, one piece spring body.

Two legs 612 and 613 of the spring clip 61 respectively has a substantially, diametrically symmetrical opposed free end sections to permit a substantially radial movement of the pair of opposed free end section in following a fastening operation within the enlarged diameter internal bore potion 213a. A free end section of the first leg 612 has a engaging terminal end potion 614 for engaging with the sidewall of the poky going aperture 219, the engaging terminal end portion is passed through the poky going aperture 219 to a substantially radial inward deformation of the body against the insert end portion within the enlarged diameter internal bore potion 213a only when the annular projection 12 on the insert end portion 11 is fully inserted into the receive end portion 211 of the female element 210.

Accordingly, U or C-shape clip 61 is slidablly passed through the relatively large coming apertures 217 and 219 in the housing 210a for releasibly locking the male 10 and female element 220 and that non-rotatably by an intervention of the large high friction element 31.

In the fastening position, it is obvious that the relative rotation between the spring clip 61 and the female element 210 is prevented. Because the first leg 612 pass through large aperture 217 and the poky going aperture 219, and then, its wave shaped engaging projection portion 614 is engaged an one sidewall of the poky going aperture 219.

On the other hand, retainer 31 is fastened against the outer peripheral of the a front area 13 of the insert end portion 10 by spring clip 61 at the same time. Thus, the relative rotation between retainer 31 and insert end portion 10 is restrained because retainer 31 not only can function as a retainer element but also a large high friction element.

Therefore, the relative rotation between male element 10 and female element 210 can restrain.

More particularly, FIG. 10 is a cross-section view similar to that of FIG. 9 but showing a U-shaped spring clip 61 is in the fasten position. In the fasten position, the first leg 612 is forcibly inserted till its waved engaging projection 614 passes through the poky going aperture 219 and engages the poky going aperture 219. While the second leg 613 is forcibly inserted till its relatively large rolled engaging projection 615 passes through the large aperture 217 and flexibly, tightly engages the flat outer surface 313a of the retainer 13 at the same time.

It will be noted that the spring clip 61 can fasten the retainer 13 against the insert end portion 11 only when the insert end portion 11 is fully inserted into receipt end portion 211. If the male element 10 did not fully insert into the axial bore 213, the spring clip 61 cannot moved from the open position (FIG. 9) to the fastening position (FIG. 10).

Also, a maintenance man can put back the spring clip 61 from the fastening position to the open position by pushing up the relatively large rolled engaging projection portion 615 of the clip 61 with his finger via the relatively small aperture 218.

Furthermore, he can not only loose clip 61 but also can disconnect the male element 10 and female element 210 each other by using the well known cylindrical releasing tool (not shown), next, retainer 31 and the set of seals comprising the O-rings 51 and 51, a top bushing member 56 and an interposed spacer 55 can take out from the receipt end portion 211. Thus these wear-affected elements can easily be exchanged.

Therefore, according to the first embodiment of the connector assembly, the male element 10 and female element 210 can easily, disconnectablly, non-rotatably be locked (connected) together. Also U-shaped spring clip 61 not only can function as fastener means but also visual indicator device for indicating the male element and female element are completely connected each other.

According to the first embodiment of the connector assembly, furthermore, an axial pull-apart strength between the male element 11 and female element 210 is added, and then tight connection between the male element 11 and female element 210 is assured. Because, C-shaped retainer 31 is radially inwardly fastened by U-shaped spring clip 61 after the retainer 31 is engaged the back surface 12b of the annular projection 12 on the insert end portion 11 for resisting the disconnection between the male element 10 and the female element 210. In this case, retainer 31 is fastened from its outside against the hinder area 14 of the insert end portion 11 by. U-shaped spring clip 61.

Yet another, when C-shaped retainer 31 is fastened against the insert end portion 11 by U-shaped spring clip 61 in the locked portion. C-shaped retainer 31 can protect the dust penetrating into push-in space between the insert end portion 10 and receipt end portion 211, because the retainer 31 can sealingily cover the outer peripheral of the insert end portion 11. In addition, as the space between the separating both ends of the resilient C-shaped retainer 31 is approached each other when the U-shaped spring clip 61 is forcibly moved from the open position (FIG. 9) to the fastened position (FIG. 10), according to an another preferable C-shaped retainer (not shown), its space can design zero. Therefore, according to a desirable variation of the C-shaped retainer in the first embodiment of the connector assembly, which can be protected the dust penetrating into push-in space between the insert end portion and receipt end portion in the locked portion.

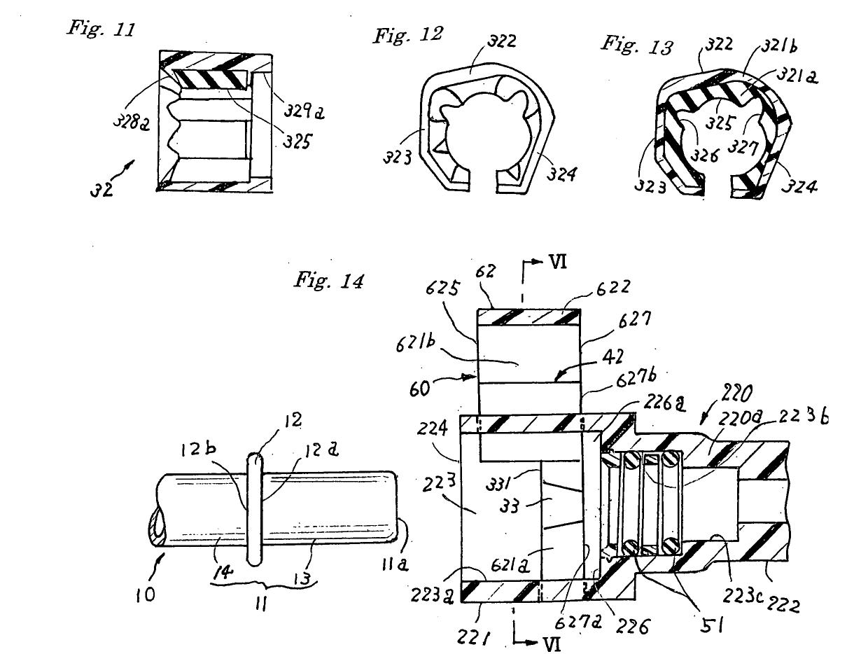

FIG. 11 depicts a modification of the C-shaped retainer which operates in substantially the manner as the retainer 31 described above.

Referring to FIG. 11-13, a modification of the first embodiment of a generally C-shaped retainer 32 similar to retainer 31 is shown. But a gain generally C-shaped retainer 32 composed of two layer which was formed integral with a C-shaped thick inner layer 321a and a U-shaped thin outer layer 321b. The C-shaped inner layer 321a is made from large high frictional material, such as rubbers to produce the torque resistance. On the other hand, generally U-shaped thin outer layer 321b made from small low frictional material, such as Nylon 11. Generally C-shaped thick inner layer 321a can function as a large high friction element, then the C-shaped thick inner layer 321a can dispose for securely engaging with the outer peripheral surface of the insert end portion 11 when the U-shaped clip is inserted into the fasten position. On the other hand, U-shaped thin outer layer 321b serves for easier inserting and easier reciprocally removing of the U-shaped spring clip 61 by sliding an outer surface of the U-shaped thin outer layer 321b.

Accordingly, generally C-shaped retainer 32 having a generally cylindrically shaped resilient body 321 which is formed as substantially C shaped in cross section similar to generally C-shaped retainer 31 and includes a cross base 322 and two side legs 323 and 324. The retainer 32 further includes axially extending substantially a circumferential inner surface 314 extends between tapered inner peripheral surface 318a and stepped annular recess 319a. as well as the retainer 31 described above and shown in FIGS. 3 and 4.

Also, circumferential inner surface 325 includes a pair of acuate shaped recesses 326 and 327 formed with the both inner corner portions positioning the jointed two side legs 323 and 324 to the rectangular base 322 in the C-shaped inner layer 321a.

Each inner carved recesses 325 and 326 assist the sufficient radial deformation of the retainer 32, therefore the first and second inner carved recesses 325 and 326 permits a radial sufficient expansion and a compression of the retainer 32 when the male end portion into the female end portion.

Referring now to FIG. 14 in particular, there is depicted one of a second embodiment of the connector assembly of the present invention. This connector assembly includes a tubular male element 10 which is similar to the conduit 10 in the first embodiment, a disconnected tubular female element 220 and a U-shaped fastener device 60 which serves as well for a large high friction element and a retainer element.

Female element 220 may be made from any switable material, such as plastic or metal, and may have any appropriate outer shape, such as a cylinder or a hex construction. The female element 220 includes a housing 220a, which is formed with axial bore 223. The housing 220a provides an enlarged diameter bore potion 223a at a receipt end portion 211 adjacent to one open end 224 to receive an inserting end portion 11 of the male element 10 and a reduced diameter potion 222 at an other end.

Receipt end portion 221 is formed with most enlarged first diameter internal bore portion 223a, the second internal bore portion 223b and the third internal bore portion 223c respectively extending axially from one open end 224, which adapt to receive the insert end portion 11.

A pair of the diametrically symmetrical apertures 227 and 227 crosses the first diameter bore portion 223a (receipt end portion 221) and is formed in a circular wall of the receipt end portion 221 to mount so that the U-shaped fastener body 62 can be moved.

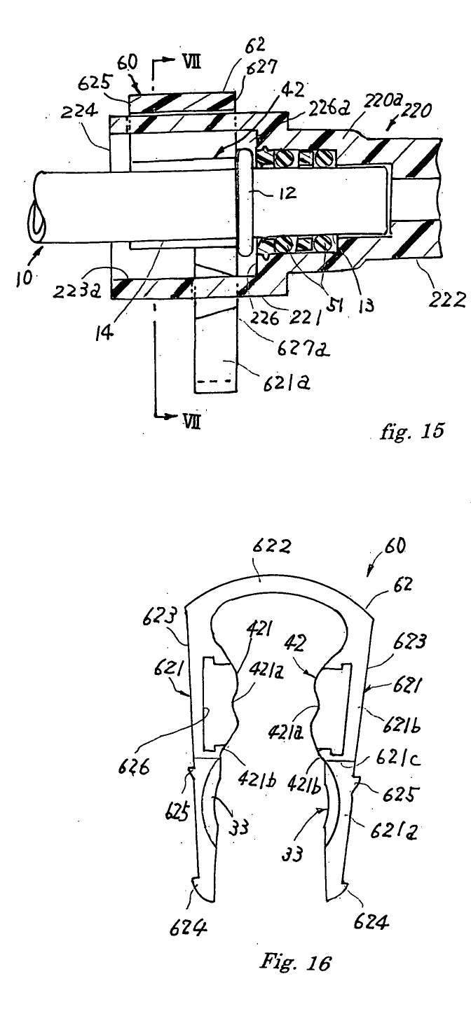

Referring to FIG. 14, axial view of a disconnected female element taken at the fastener device 60 receiving the first diameter internal bore portion 223a via the apertures 227 and 227 is shown. And the fastener device 60 is in the open position as described hereafter. Referring to FIG. 15, the male element 11 is fully inserted into the receipt end portion 211 of the female element, and the fastener device 60 received in the receipt end portion 211 via the apertures but showing the fastener device 60 is in the fastened position as described hereafter.

It can be seen from FIGS. 14 and 15 that a radially inwardly extending annular surface 226 is formed between the first enlarged diameter internal bore portion 223a and the second enlarged diameter internal bore portion 223b for limiting an axially inwardly movement of the male element 10. The first enlarged diameter internal bore portion 213a having an axial length sufficient to receive the annular projection 12 on the insert end portion 11. In addition, a fastener device 60 formed as generally U-shaped in cross section is received receipt end portion via the transverse apertures 227 and 227 in natural state as shown in FIG. 14.

Referring to FIG. 16, a front elevation view of a fastener device 60 is shown in natural state. Generally U-shaped spring fastener device 60 includes a U-shaped spring fastener body 62 and a large high friction element 42, and fastener body 62 is integral with large high friction element 42.

Generally U-shaped fastener body 62 is essentially in the form of a unitary, spring one piece body formed as generally U-shaped in cross section which is made from any suitable material, such as plastic or relatively thin walled metal plate. U-shaped spring fastener body 62 includes a cross member 622 and two legs 621, 621 spaced apart and extending generally in parallel from the cross member 612. In addition, a pair of generally opposed parallel elongated legs 621 and 621 joined at a connected end by a cross member 622, and two legs 621 and 621 can respectively obliquely deform to permit radial movement of a terminal end thereof within the enlarged diameter internal bore potion 223a as described hereafter.

In this embodiment, U-shaped fastener body 62 made from plastic, such as Nylon 11. a pair of opposed parallel legs 621 and 621 respectively includes opposite straight exterior surface 623 and 623, a pair of first engaging projection 624 and 624 which respectively outwardly projected from the straight exterior surface 623 and 623 at terminal end potion of the legs 621 and 621 and a pair of second projection 624 and 624 which outwardly projected from the straight outer surface 623 and 623 at a middle potion of the legs 621.

The first leg 621 extends from a connected end to a terminal end, and includes a relatively thick end portion (engaging terminal end portion) 621b and a relatively thin end portion 621a for forming a step 621c between a connecting end side (thick) portion 621b and a terminal side (thin) end portion 621a. Accordingly, thin end portion 621a has a step down surface 331 between one side 625 and the other side surface 627 as shown in FIG. 14. And then, thick connecting end portion 621b is integraly provided with a large high friction element 42 at an interior recess 626 thereof. On the other hand, the thin end portion 621a is unitary provided with an acuate shaped sloping lead area 33.

The large high friction element 42 is made from large high friction material, such as rubber, and which is secured in the interior recess 626 formed with connecting end portion 621b of the leg 621. The large high friction element 42 includes an inwardly projected project portion 421 having a pair of opposed central acuate slots 421a and 421a adapted to forcibly hold a hinder area 14 of the insert end portion 11 which is axially fully inserted into the receipt end portion 221.

Also, the acuate shaped interior sloping lead area 33 substantially radially inwardly inclines from the step down surface 331 toward the other side surface 627 in a direction for force required to insert an annular projection 12 of the conduit 10, as described hereafter when the fastener device 60 in the open position.

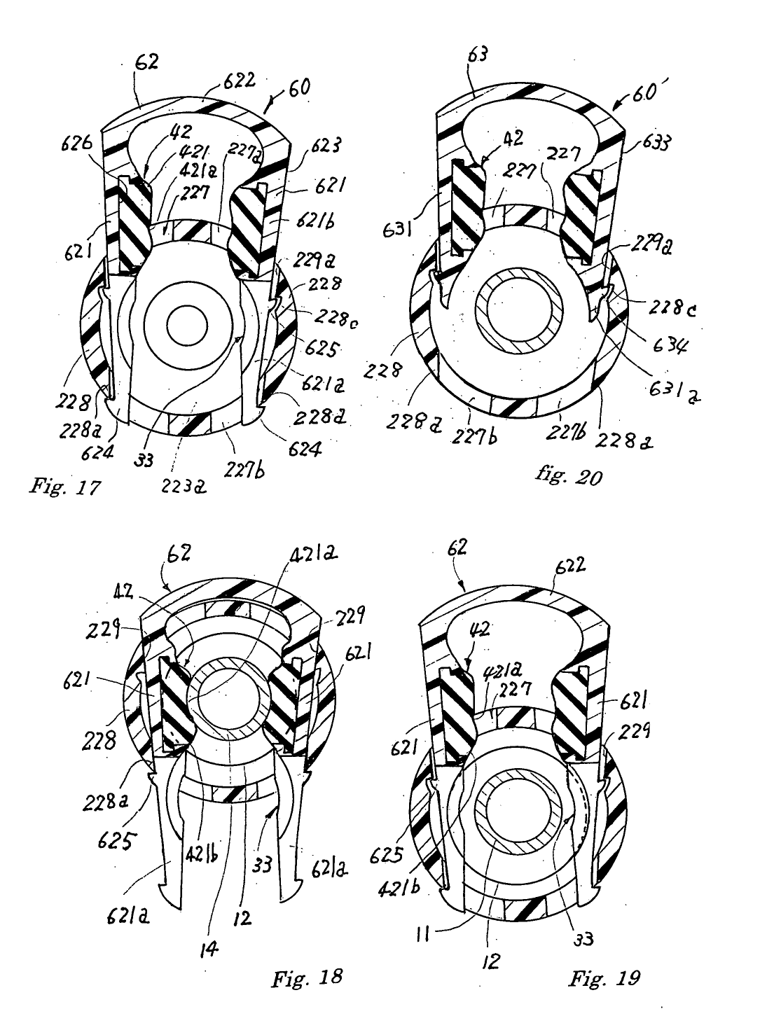

It can be seen from FIG. 17 that a pair of generally parallel transverse apertures 227 and 227 are circumferentially arranged by diametrically symmetrically forming offset with a pair of opposite circumferential portions 228 and 228 in the circular wall of the receipt end portion 221.

In addition, a pair of generally parallel transverse apertures 227 and 227 are respectively separated by a partition walls for reinforcing the receipt end portion 221. Bat, a variation (not shown) of the parallel apertures are not necessary a pair of partition walls.

A pair of generally parallel transverse apertures 227 and 227 is respectively designed to be able to slidably pass through two legs 621 and 621 of the fastener body 62 from coming apertures 227a and 227a to a going apertures 227b and 227b.

A pair of generally parallel transverse apertures 227 and 227 serves for constituting a V-shaped internal wedge. Thus for example, a pair of symmetrical taper surfaces 229 and 229 are substantially faced apart each other. A pair of opposite circumferential portions 228 and 228 respectively includes the first edge portions 228a and 228a and the second end portions 228b and 228b. The first edge portions 228a and 228a and the second end portions 229b and 229b respectively include the first taper defining surfaces 229a and 229a and the second taper defining surfaces 229b and 229b. the first taper defining surface 229a is flush with the second taper defining surface 229b to form the V-shaped internal wedge.

Therefore, a pair of symmetrical taper surfaces 229 and 229 adapt to substantially bias radially inwardly the symmetrically opposite legs 621 and 621 respectively along them.

A pair of first engaging projections 624 and 624 of the U-shaped fastener body 62 initially engage a pair of fiarst second edges portion 228a and 228a when the two legs 621 and 621 are radially insert into the pair of opposed generally parallel transverse apertures 227 and 227. espectively. While the second engaging projections 625 and 625 are received a pair of recesses 228c and 228c which are formed with a pair of diametrically symmetrically opposite circumferential portions 228 and 228 adjacent to its first taper defining surface 229a and 229a.

Accordingly, U-shaped fastener body 62 previously, movably mounted in the receipt end portion 221 of the female element 220 through a pair of coming apertures 227a and 227a when the U-shaped fastener device 60 is in the open position.

In the open position, it will be noted that, in the open position (FIGS. 14 and 17), a pair of symmetrical taper surfaces 229 and 229 being substantially spaced apart a predetermined distance which is slightly greater than the width of the U-shaped fastener body 62. Because it allows a symmetrical, radial movement and/or deformation of the legs 621 and 621 when the male element is inserted into the female element for locking together.

Also, opposite arcuate shaped sloping lead areas 33 and 33 are positioned concentric with a center axis within the enlarged diameter internal bore potion 223a when the U-shaped fastener device 60 is in the open position as shown in FIG. 17. More particularly, a connector assembly of the second embodiment is designed to produce an axially space 226a between the radially inwardly extending annular surface 226 and an other side surfaces 627 of the fastener body 62 as shown in FIG. 14. This space 226a serves for receiving an annular projection 12 on the insert end portion 11 when the male element 210 axially inserts into the receipt end portion 211.

When an assembly worker forces one's way the U-shaped fastener device 60, can be moved from the open position until a fastening position as shown in FIG. 19. A pair of the second engaging projections 625 and 625 formed with U-shaped fastener body 62 resiliently are engaged the pair of first edge portion 228a, 228a of the opposite circumferential portions 228 and 228 by sliding into along the symmetrical taper surfaces 229 and 229.

Also, a predetermined distance of the space between two legs 621 and 621 are narrowed by operation of a pair of taper surface 229 and 229 when the U-shaped fastener device 60 is forcibly moved from the open position (FIG. 19) to the fastening position.

In the fastening position, opposite large high friction elements 42 and 42 are respectively disposed substantially concentric to a center axis within the enlarged diameter internal bore potion 223a. And then, diametrically symmetrical opposed large high friction elements 42 and 42 are radially spaced apart a predetermined distance which is small more than outer diameter of the hinder area 14 of the insert end portion 11.

Operation and assembly of the connector assembly as disclosed in FIGS. 14, 15, 17, 18 and 19 will now be provided.

It can be seen from FIGS. 14 and 17 that an annular sealing element 51 and 51 and U-shaped fastener device 60 are previously disposed to the receipt end portion 211 of the female element 220. Thus for example, the seal ring 51 and 51 are initially disposed into the second diameter internal bore portion 223b by axially inserting from an one open end 224, next, two legs 621 and 621 of the U-shaped fastener device 60 is disposed by respectively passing through from the caming apertures 227a and 227a to the going apertures 227b and 227b transverse the most enlarged first diameter internal bore portion 223.

Annular sealing element 51 recieves a fluid tight seal between confronting portions of the tubular male element 10 and the tubular female element 220 when the male element 10 is fully inserted in to the female element 220.

A pair of first engaging projections 624 and 624 of the U-shaped fastener body 62 initially engage a pair of fiarst second edges portion 228a and 228a.

A pair of the first engaging projections 624 and 624 formed with legs 621 and 621 of the U-shaped fastener body 62, which are respectively engaged the pair of first edge portion 228a and 228a of the opposite circumferential portions 228 and 228 when the. U-shaped fastener device 60 is in the open position (FIGS. 14 and 15). Thus, a pair of acuate shaped sloping lead areas 33 and 33 are positioned concentric with a center axis within the enlarged diameter internal bore potion 223a.

It can be seen from FIGS. 14 and 19 that the annular projection 12 on the insert end portion 11 forces against a pair of opposed acuate shaped sloping lead areas 33 and 33 forming with the free end portion 228a and 228a when the male element 10 is inserted into female element 210. Therefore, two legs 621 and 621 and/or the thin end portions 621a and thin end potion are so spread easily, that U-shaped fastener body 62 allows the annular projection 12 through along the acuate shaped sloping lead areas 33 and 33. Once the annular projection 12 passes through the pair of arcuate shaped sloping lead areas 33 and 33, a pair of thin end portions 621a and 621a snap back to engaging its back surfaces 12b to the other side surfaces 627a of thin end portion 621a. And then the annular projection 12 snap into the axial space 226a of the receipt end portion 221 at the same time as shown in FIG. 19, it permits easy swivelable connection of the male element 10 and female element 220 when the insert end portion 11 is fully inserted into the receipt end portion 221. Therefore, the male 10 and female element 220 is tight sealinglly and rotatably connected (locked) each other.

In addition, it will be noted that the male element 10 and the female element 210 are only rotatably locked each other similar to the first embodiment. Also, the male element 10 and the female element 210 can easily disconnect each other by using the well known cylindrical releasing tool (not shown).

According to a preferable second embodiment of a connector assembly of the present invention, U-shaped fastener device 60 is radially, forcibly can move from the open position (FIG. 19) to the fastening position (FIGS. 15 and 18) after the male 10 and female element 220 is initially rotatably, completely connected (locked) together. Therefore a relative rotation between the male 10 and female element 220 is restrained. More particularly, a predetermined distance of the space between two legs 621 and 621 are narrowed by operation of a pair of taper surface 229 and 229 while an engaging areas of a pair of inner surfaces of two legs 621 and 621 and the insert end portion 11 respectively moved, via a pair of caming surfaces 421b and 421b, from a center of the acuate shaped sloping lead area 33 to a center of acuate slot 421a and 421a on the large high friction element 42 in the each interior of both legs 621 and 621 to hold the insert end portion 11 between two large high friction elements 42 and 42 when the U-shaped fastener device 60 is forced one's way (push) from the open position (FIG. 19) until the second engaging projections 625 and 625 on each of the legs 621 and 621 respectively resiliently engage the pair of second edge portions 228b and 228b of the opposite circumferential portions 228 and 228 by sliding along the symmetrical taper surfaces 229 and 229.

Therefore, a large high friction element 42 and 42 respectively, substantially disposed circumference direction space apart each other between insert end portion 11 and leg 621 of the fastener body 62 concentric with a center axis in the fastening position. Also, large high friction elements 42 and 42 are fastened against the hinder area 14 of the insert end portion 11 by U-shaped fastener body 62. Because posed acuate slots 421a and 421a are radially spaced apart a predetermined distance which is decreased to become too small more than outer diameter of the hinder area 14 of the insert end portion 11 in the fastening position.

Accordingly, fastener body 62 is slidabily passed through the apertures 227a and 227b in the housing 22oa between the male element 10 and fastener body 62 for releasibly locking the male 10 and female element 220 and that non-rotatably by an intervention of the large high friction element 42 and 42.

In addition, both coming surfaces 421b and 421b respectively extend between an acuate shaped sloping lead area 33 and an acuate slot 421a for easily fastening the a pair of the large high friction elements 42 and 42 against the hinder area 14 of the insert end portion 11.

Once a pair of acuate slot 421a and 421a are engaged the outer peripheral of the end portion, a pair of the large high friction elements 42 and 42 are disposed concentric with the end portion 11. And then, relative rotation between U-shaped fastener body 62 and the male element 10 is restrained. On the other hand the fastener body 62 is non-rotatably coupled the receipt end portion 211. Therefore, relative rotation between the male and female element 10 is restrained.

According to the second embodiment of a connector assembly, U-shaped spring fastener body 62 includes two legs 621, 621 spaced apart and extending generally in parallel from the cross member 612. Two legs 621, 621 are so movably attached to the receipt end portion 221 of the female element 210 for fastening a pair of diametrically symmetrically opposite circumferential large high friction elements 42 and 42 against the insert end portion 11 of the male element 10 which is fully inserted into the receive end portion 211 of the female element 220, as to be substantially diametrically, symmetrically able to dispose the outside of a pair of the large high friction elements 42 and 42.

Two legs 621 and 621 respectively include a substantially, diametrically symmetrical free end section within the enlarged diameter internal bore potion to permit a substantially radial movement of the body 62 to fasten the diametrically symmetrically opposite large high friction elements 42 and 42 with a fastening operation of the U-shaped spring fastener body 62.

A pair of free end sections respectively include a terminal end portions which are respectively integral with a pair of terminal through end portions 621a and 621a which are respectively passed through a caming aperture 227a and a going aperture 227b.

A pair of terminal end portions 621a and 621a respectively engage a pair of symmetrical taper surfaces 229 and 229 of the aperture 227 and 227 defining a side wall for preventing a rotational movement between the U-shaped spring fastener body 62 and the female element 220 when the spring fastener body 62 fastens the large high friction element 42 and 42 against the insert end portion 11.

That is to say, the fastener device 60 is initialy, movably mounted in the receipt end portion 221 of the female element 220. Next, only when the insert end portion 11 is fully inserted into the receive end portion 211. Its two legs 621 and 621 concentricly, radially fasten the a pair of opposite large high friction element 42 and 42 against the insert end portion 11 of the male element 10 in operative relation to a fastening operation. Thus, tow large high friction elements 42 and 42 are substantially diametrically, symmetrically dispose the inside of the legs 621 and 621 within the most enlarged first diameter internal bore portion 213a.

Accordingly, it is possible to compose a similar connector assembly, but a large high friction element is previously integral with outer peripheral of an insert end portion of the male element.

In addition, U-shaped fastener device 60 so movably attached to the receipt end portion of the female element as to be substantially diametrically, symmetrically able to dispose the outside of the large high friction means, for fastening the large high friction means against the insert end portion of the male element which is fully inserted into the receive end portion of the female element.

Two legs 621 and 621 are confined by pair of symmetrical taper surfaces 229 and 229 when the U-shaped fastener body 62 is in the fastening position (FIGS. 15 and 19). Accordingly, male element 10 is tightly secured to female element 220 by U-shaped fastener device 60 via the large high friction elements 42 and 42. Because, the receipt end portion 221 includes some side□wall defining the apertures 227 and 227 having a V-shaped internal wedge which is defined a pair of diametrically symmetrically opposite taper surfaces 229 and 229 of the side-wall of the side□wall defining the apertures 227 and 227 at the receipt end portion 221. But, a different modification of a receipt end portion including a pair of opposite apertures, which can achieve the primary object of the present invention, even if the apertures have not opposite taper surfaces.

It will be noted that for locking the male and female element together., in the open position (FIGS. 14 and 19), a pair of symmetrical taper surfaces 229 and 229 being substantially spaced apart a predetermined distance which is slightly greater than the width of the U-shaped fastener body 62 to allow the deformation, such as spreads of two legs 621 and/or these thin end portions 621. It is obvious that the fastener device 60 can only move from the open position (FIG. 19) to the fastening position (FIG. 18) when the insert end portion 11 fully inserted into the receipt end portion 221 similar to the U-shaped clip 61 in the first embodiment of the connector assembly. According to the second embodiment of the connector assembly, U-shaped fastener device 60 not only can function as fastener means but also visual indicator device for indicating the male element and female element are completely connected each other similar to the U-shaped clip 61 in the first embodiment.

Also, C-shaped fastener body 62 provided with a pair of large high friction elements 42 and 42 at each interior of two legs 621 and 621 thereof. And a pair of large high friction elements 42 and 42 are fastened against the hinder area 14 elongated from the back surface 12b of the annular projection 12 on the insert end portion 11 by fastener body 62, thus, such fastener body receives as well for a retainer element. Therefore, tight connection between the male element 11 and female element 210 is assured.

Referring to FIG. 20, a modification of a U-shaped fastener device in the second embodiment is shown. This U-shaped fastener device is mounted in the female element 220 similar construction to foregoing female element 220, U-shaped fastener device 60′ is in the open position. U-shaped fastener device 60′ includes fastener body 63 and a pair of large high friction elements 42 and 42 similar to foregoing U-shaped fastener device 60. And then fastener body 63 is integral with large high friction element 42.

Two legs 631 and 631 of the fastener body 63 are shorter than leg 621 of the foregoing fastener body 62 and do not provide both an acuate shaped sloping lead area 33 and the second engaging projections 625 as well as forgoing fastener body 62. Thus, terminal end portion 631a of leg 631 is formed adjacent to an interior recess portion 636 laid the large high friction elements 42 and the first engaging projection 634 is formed with outwardly projected from the straight exterior surface 633 at the terminal end potion 631a. And, the first engaging projections 634 is engaged with recess 228c which are formed with a pair of diametrically symmetrically opposite circumferential portion 228 adjacent to its first taper defining surface 229a when the fastener device 63 is in the open position. It can be imagine from FIG. 20 that next, U-shaped fastener device 60′ is forcibly moved from the open position (FIG. 20) to the fastening position (not sown) by same way. as foregoing fastener body 62 such that, in a pair of identical symmetrical transverse apertures 227 and 227, the U-shaped fastener device 63 is forced one's way from the open position until the first engaging projections 634 and 634 resiliently engage the pair of first edge portions 228a and 228a of the opposite circumferential portions 228 and 228 along the symmetrical taper surfaces 229a and 229a. Thus, this U-shaped fastener body 63 operates in substantially the manner as the fastener body 62 described above.

Accordingly, according to the second embodiment of a connector assembly, forgoing a pair of acuate shaped sloping lead area 33 and 33 formed with the thin end portion 621a is not necessary. Because it is sufficient that fastener body 62 can move from open position to fastening position only when the insert end portion 11 is fully inserted into receipt end portion 221.

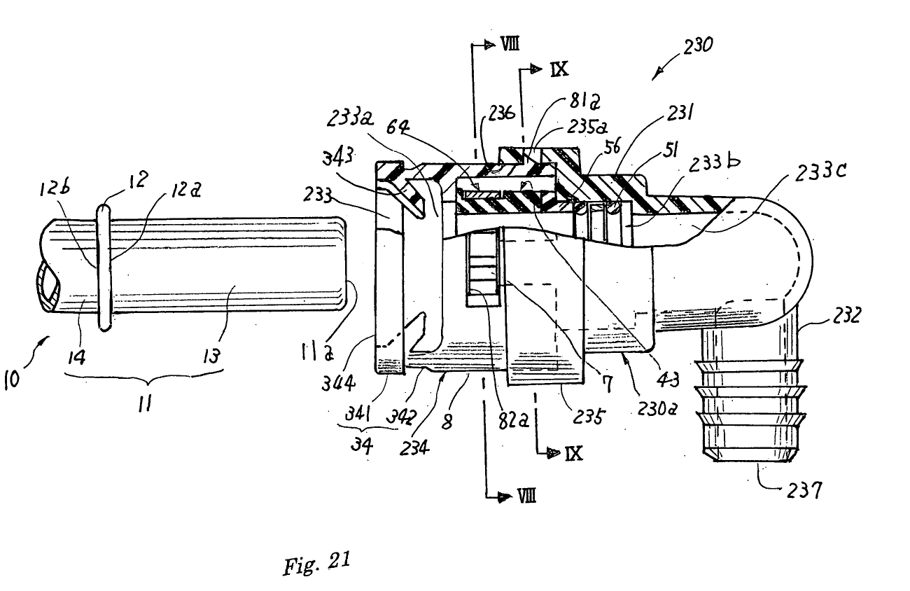

Referring now to FIG. 21-30, there is depicted third one embodiment of the connector assembly of the present invention.

Referring to FIG. 21, a partly longitudinal section view of a connector assembly according to a present invention is shown. The connector assembly includes a relatively disconnected tubular male element 10, an elongated tubular female element 230 adapted to convey fluid, a cylindrical retainer device 234 provided with the female element 230, a cylindrical large high friction element 43 previously mounted into a receipt end portion of the female element 230 and a generally ring-shaped spring clip 64 for fastening the large high friction element. In addition, ring-shaped spring clip 64 is in the expantion state by operation of U-shaped holder device 7.

A female element 230 is comprised of a substantially cylindrical retainer device 234 and an elongated tubular sleeve 230a which may be formed of a suitable plastic material in a suitable injection molding operation. And cylindrical retainer device 234 is detachably coupled the sleeve 230a.

Such female element 230, as a whole, includes an elongated tubular housing and having a one open end 344 and the other open end 237. An axially extending stepped axial bore 233 is formed between the housing ends and this axial bore 233 forms a fluid passageway through the female element 230.

Sleeve (housing) 230a having an stepped axial bore, the stepped axial bore extends therthrugh from an enlarged opening end portion 235 to a reduced diameter other end portion 232. And then, sleeve 230a includes an enlarged opening end portion 235, the other end portion 232 and a middle portion 231 between them.

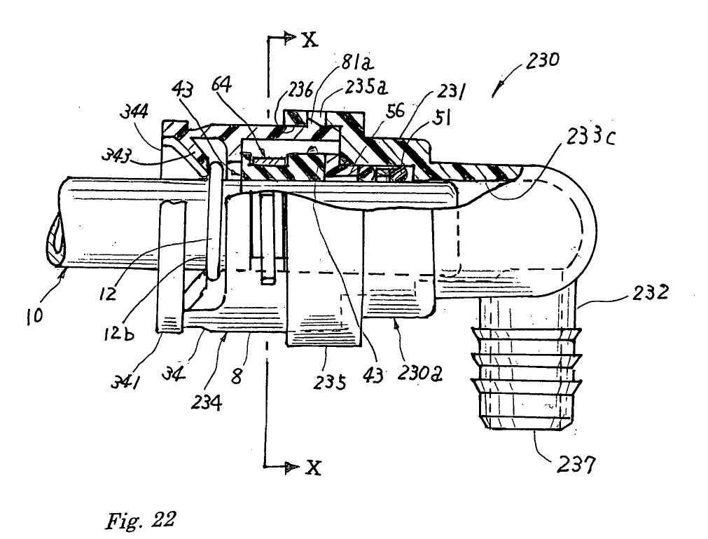

Enlarged opening end portion 235 includes an enlarged diameter receive internal bore portion 236 for receiving to couple with the cylindrical retainer device 234. Middle portion 231 includes the second smaller diameter internal bore portion 233b for mounting an annular seal element 51. Other end portion includes third yet smaller diameter internal bore portion 233c for receiving the front area 13 of the insert end portion 11 of the male element 10 when the insert end portion 11 is fully inserted into sleeve 230a of the female element 230 as shown FIG. 22. In addition, An enlarged open end portion 235 further includes a pair of diametrically symmetrical engaging holes 235a and 235a radially passed through its cylindrical wall for coupling the retainer device 234.

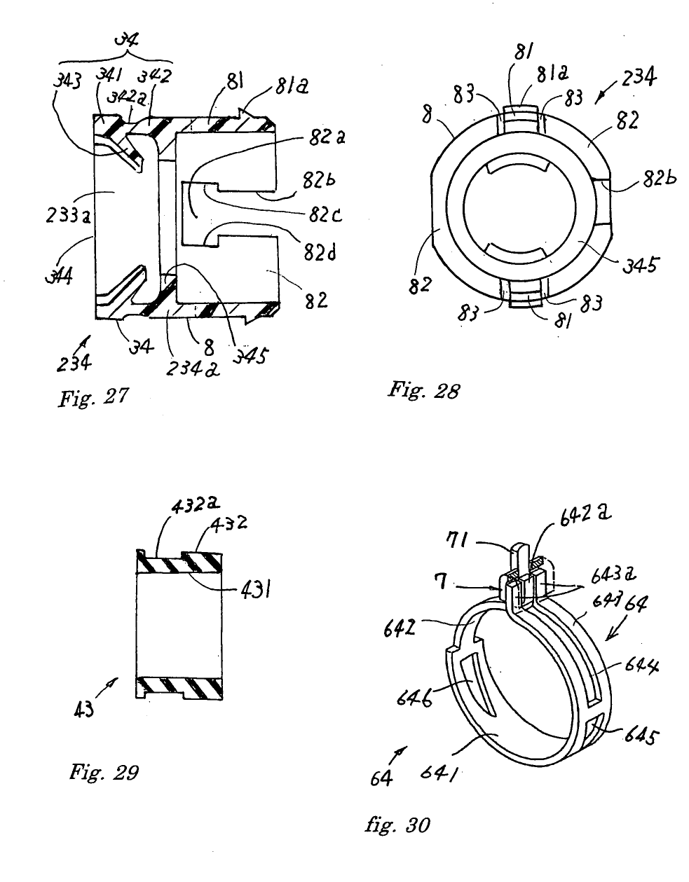

Referring to FIGS. 21-28, a cylindrical retainer device 234 is detachably coupled the sleeve 230a as described hereafter. Cylindrical retainer device 234 includes an axially extending cylindrical, unitary one piece body 234a formed with an axial bore 233 which extends from one open end 344 to the other end. Body 234a includes a unitary a retainer element 34 at one end adjacent to an open end 344 and a collar 8 at the other end as shown in FIG. 27. Body 234a further includes an enlarged diameter internal bore potion 233a adapt to axially receive the insert end portion 11 of the male element 10.

The enlarged diameter internal bore potion 233a having an axial length sufficient to receive the annular projection 12 on the insert end portion 11 of the male element 10 and a cylindrical large high friction element within the enlarged diameter internal bore potion 233a. The circumferential inner surface of the retainer device 234 is provide with a radially inwardly extending annular flange 345 between the retainer element 34 and collar 8 for limiting the movement of male element 10 when the male element 10 is inserted into the retainer device 234 from its one open end 344.

Retainer element 34 includes a ring portion 341, a pair of diametrically symmetrical beams 342 and 342 and a pair of diametrically symmetrical resilient fingers 343 and 343. as shown in FIG. 27 And then, ring portion 341 is connected to two beams 342 and 342 via both hinges 342a and 342a. A pair of diametrically symmetrical resilient fingers 343 and 343 are respectively integrally formed with a pair of diametrically symmetrical portions of the ring portion 341 adjacent to the one opening end 344, and extend radially inwardly from the ring portion.

Collar 8 can be detachably coupled the sleeve 230a by sliderably inserting into the enlarged diameter receive internal bore portion 236 formed enlarged open end portion 235 of the sleeve 230a as shown in FIG. 21.

More particularly, the collar 8 is integral formed with a pair of diametrically symmetrical lugs 81 and 81 and a pair of diametrically symmetrical circumferential portions 82 which are disposed circumferentially slited apart each others and both lugs 81 and 81 and both circumferential portions 82 extend axially therefrom towards the sleeve 230a.

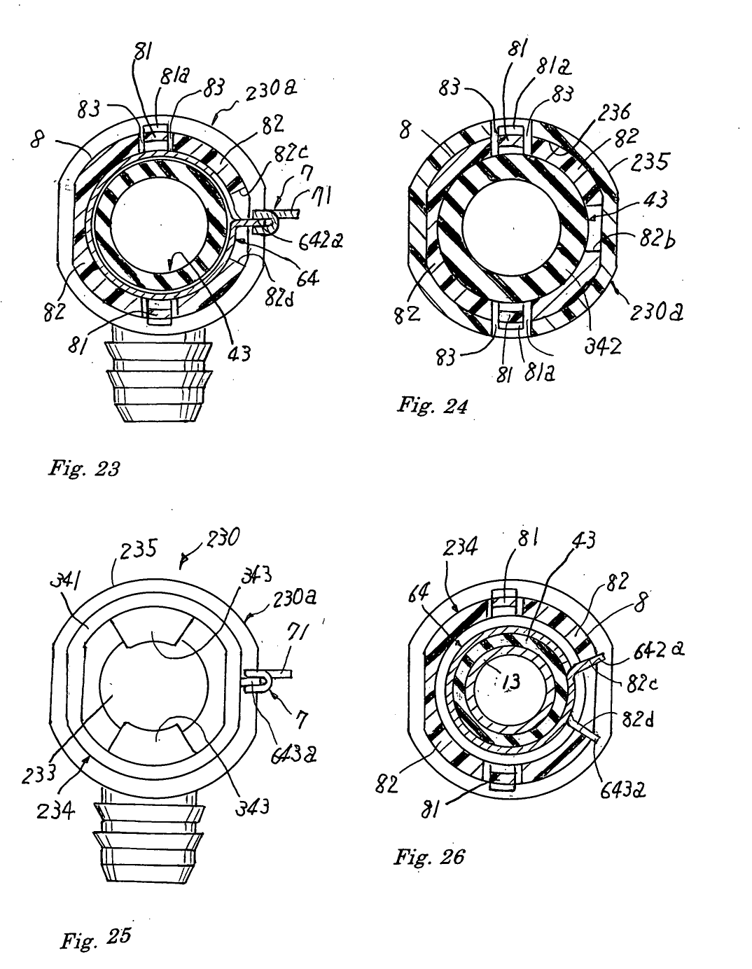

It can be seen from FIGS. 21 and 23, both lugs 81 and 81 respectively include a radially outwardly projecting détente 81a which engages with a engaging hale 235a formed with an enlarged opening end portion 235 of sleeve 230a.

Referring to FIGS. 24, 27 and 28, a pair of lugs 81 and 81 and a pair of circumferential portions 82 and 82 are mutually arranged offset with the respect to one another by 90° via the slits 83 and 83.

In addition both the thickness of two deformable lugs 81 and 81 are thin than both circumferential portion 82 and 82 to permit a détente 81a to be biased radially inwardly. One of the diametrically symmetrical circumferential portion 82 includes an aperture 82a and a cut 82b which is cut from the aperture 82a to the other end. The cut 82b receive for mounting a cylindrical large high friction element 43 into collar 8 with spring clip 64. Referring to FIG. 29 cylindrical large high friction element 43 maid from rubber, and large high friction element 43 includes an inner peripheral surface 431 having inner diameter approximately equal to outer diameter of the front area 13 of the inset end portion 11 and an outer peripheral surface 432 having outer diameter approximately equal to an inner diameter of the collar 8 of retainer device 234. And then, the outer peripheral surface 432 is formed with an annular groove 432a near the one end thereof to receive the ring-shaped spring clip 64.

Ring-shaped spring clip 64 is initially used in an expansion state for rotatably locking the male element 10 and female element 230 together. That is to say, ring-shaped spring clip 64 is initially mounted surrounding an outer peripheral surface of the annular groove 43a in an expansion state maintained tensioned state by using a U-shaped holder device 7 as best shown FIG. 23 of the drawing.

Referring to FIG. 30, this ring-shaped spring clip 64 is in form of a unitary, one piece body which is circularly formed by spring plate and has free end section 642 and 643 overlapped in the peripheral direction. The body is formed of suitable material such as metal plate. Each end section 642 and 643 has an approximately radially outwardly directed tensioning knob 642a and 643a from both end portions of ring 641, respectively. Spring clip 64 has three openings 644, 645, and 646, which extend in the peripheral direction. One end section 642 passes through opening 644 to overlap end section each other.

Accordingly, spring clip 64 can resiliently expand diameter by approaching each tensioning knob 642a and 643a, and can maintain the tensioned state by U-shaped holder device 7 holding an approached tensioning knobs 642a and 642a. Accordingly, spring clip 64 maintained in expantion state initially can mount within the annular groove 43a of the cylindrical large high friction element 43. Finally, spring clip 64 can fasten the large high friction element 43 against the insert end portion 11 of the male element 10 by removing the U-shaped holder device 7 from two tensioning knob 642a and 643a of spring clip 64 as described hereafter.

In addition inside diameter of the spring clip 64 in tensioned state is fully lager than that of the in non-tensioned state and is slightly lager or an approximately equal compare with diameter of the annular groove 43a formed an outer peripheral surface of the large high friction element 43.

Also, inside diameter of the spring clip 64 in non-tensioned state (in the natural state) is smaller than diameter of the annular groove 43a of the large high friction element 43. Such a spring clip 64 is resemble to a hose clip in J. P publcation No. 2000-249274.

Accordingly, spring clip 64 maintained in expantion state initially can mount within the annular groove 43a of the cylindrical large high friction element 43. Finally, spring clip 64 can fasten the large high friction element 43 against the insert end portion 11 of the male element 10 by removing the U-shaped holder device 7 from two tensioning knob 642a and 643a of spring clip 64 as described hereafter.

It can be seen from FIGS. 21 and 23 that foregoing the cylindrical large high friction element 43 mounted spring clip 64, which is previously received into the collar 8 of the retainer means 234 for constituting the female element 230. More particularly, tensioning knobs 642a and 643a of spring clip 64 can dispose radially outwardly passed through the aperture 82a because tensioning knobs 642a and 643a approached each other can axially move passing through the cut 82b. Thus, tensioning knobs 642a and 643a are held by holder 7 and are radially outwardly projected passing through the aperture 82a as shown in FIG. 23. On the other hand, the seal element 51 and a bush 56 are previously mounted into the second diameter internal bore portion 233b in the middle portion 231 of the sleeve 230a.

Therefore, such a sleeve 230a including the seal element 51 and such a retainer device 234 including the large high friction element 43 with the spring clip 64 are detachably coupled together when the projecting détentes 81a respectively engaged the engaging hales 235a as shown in FIG. 21. And then, receipt end portion is comprised of the cylindrical retainer device 234 and middle portion 231 to receive the inset end portion 11 of the male element 10.

In addition, the cut 82b is covered by enlarged opening end portion 235, but the aperture 82a is exposed for projecting the tensioning knobs 642a and 643a of spring clip 64 from the aperture 82a to an outward.

Next, the male element 10 and female element 230 is tight sealingily and rotatably (swivelably) rocked (connected) together when the male element was fully inserted into receipt end portion 234 and 231 of the tubular female element 230. More particularly, the annular projection 12 on the insert end portion 11 forces against a pair of diametrically symmetrical resilient fingers 343 and 343 which are integrally formed with deformable ring portion 341 and beams 342 having hinge 342a. Thus, two fingers 343 and 343 engage the back surface 12b of the annular projection 12 operative to corn from the flexible deformation of the deformable portion as shown in FIG. 22. In addition, receipt end portion is formed with a retainer device 234 and the middle portion 231 of the sleeve 230a.

Finally, the spring clip 64 is reduced a diameter of the body from in the expansion state to fastening state by removing the U-shaped holder device 7 from tensioning knobs 642a and 643a of spring clip 64. In addition, U-shaped holder device 7 is provided with a grip portion 71 for removing the U-shaped holder device 7.

It will be noted that when the U-shaped holder device 7 is removed from two tensioning knob 642a and 643a of spring clip 64, ring-shaped body can substantially deform radially inwardly but a space between two tensioning knob 642a and a 643a is spread apart each other.

A circular space of the aperture 82a formed circumferential portions 82, which is designed to permit a spread of two tensioning knob 642a and a 643a, but to be resiliently engaged with opposed axially extending sidewall 82c and 82d defining the aperture 82a. when the U-shaped holder device 7 is removed from two tensioning knob 642a and 643a.

Therefore, cylindrical large high friction element 43 is fastened against the front aria 13 of the insert end portion 11 by U-shaped holder device 7. On the other had, space between two tensioning knob 642a and 643a of spring clip 64 is spread apart each other, and two tensioning knob 642a and 643a are respectively, resiliently engaged with opposed axially extending sidewall 82c and 82d defining the aperture 82a as shown in FIG. 26. In addition. Thus relative rotation between spring clip 64 and the female element 230 is prevented while relative rotation between the male element and spring clip 64 is restrained. Therefore, relative rotation between the female element 230 and male element 10 is restrained. That is to say, the female element 230 and male element 10 are substantially non-rotatably connected each other.

It will be noted that this embodiment is different from above embodiments, that is to say, the fastener means (ring-shaped spring clip 64) is coaxialy disposed spaced from the retainer element 34, different from above embodiments.

In addition, a maintenance man can put back the ring-shaped spring clip 64 from in the fastening state to the expansion state by approaching the tensioning knobs 642a and 643a of spring clip 64 using a tensioning tool (not shown).

Accordingly, the male element 10 and female element 230 can initially disconnect each other by using the well known cylindrical releasing tool (not shown). Next, retainer device 234 is detached from sleeve 230a by releasing the engagement of the projecting détentes 81a and the engaging hales 235a. Therefore, the set of seals comprising the O-rings 51 and 51 and a top bushing member 56 can take out from the middle portion 231 of sleeve 230a. 211. Thus these wear-affected elements can easily be exchanged.

When the Cylindrical large high friction element 43 is fastened against the insert end portion 11 by the ring-shaped spring clip 64 in the locked portion. Cylindrical large high friction element 43 can surely protect the dust penetrating into push-in space between the insert end portion 11 and receipt end, because the outer peripheral of the insert end portion is sealinglly covered by the large high friction element 43.

A preferred embodiment of the present invention has been disclosed. A worker of ordinary skill in the art would realize, however, that certain modifications would come within the teaching of the invention. Therefore, the following claims should be studied order to determine the scope and content of the invention.

1. A connector assembly for use in communicating a fluid media said assembly comprising:
an elongated tubular male element;
an elongated tubular male element;
a generally annular sealing element;
a retainer means;
a high friction means;
a fastener means;
the elongated tubular male element including an insert end portion axially extend from terminating in a tip end, the insert end portion providing a smooth cylindrical portion and a radially enlarged annular projection on the smooth cylindrical portion, the annular projection spaced from the tip end and the smooth cylindrical portion providing an axial hinder area and an axial front area adjacent a both end of the annular projection;
the tubular female element including a housing form with an axial bore, the housing providing an one end portion adjacent an one opening and providing an other end potion for a fluid path, the one end portion including an enlarged diameter internal bore portion having the larger internal diameter more than the other end portion, the enlarged internal bore portion providing an one side portion and an other side portion adapt to axially receive the insert end portion of the male element with the annular projection;
the generally annular sealing element disposed within the axial bore of the other end portion for providing a fluid tight seal between confronting portions of the tubular male element and the tubular female element when the insert end portion is inserted into the one end portion of the female element;
the retainer means securely provided with the one end portion of the female element, for locking the male element and the female element together, the retainer means includes a deformable portion and a lock portion, the deformable portion is provided with a unitary lock portion to engage the annular projection depend on the flexible deformation of the deformable portion when the annular projection is fully inserted into the one end portion of the female element, and the deformable portion can be deformed radially outwardly and flexibly for locking the male element and the female element;
The high friction means consists of material of rubber or elasticity, and it radially inwardly and elasticity can be deformed, and it can be secured to the enlarged internal bore potion with the fastener means to be fastened against a smooth cylindrical exterior surface of the insert end portion when the fastener means fasten the large high friction means by means of the fastening operation after the insert end portion is fully inserted into the one end portion of the female element;
the fastener means, so movably mounted within the enlarged diameter internal bore potion of the female element as to be substantially diametrically, symmetrically able to dispose the outside of the large high friction means for fastening the large high friction means against the insert end portion in operative relation to a fastening operation, the fastener means comprising substantially U or C-shaped unitary spring one piece body within the enlarged diameter internal bore potion to permit substantially radial movement of the body for fastening against the large high friction means concentric with a smooth cylindrical exterior surface of the insert end portion by means of the fastening operation.

2. The connector assembly of clam 1, wherein the large high friction element is concentricly disposed with the retainer element in the enlarged internal bore potion.

3. The connector assembly of clam 1, wherein the retainer element detachably mounted the one end portion of the female element.

4. The connector assembly according to claim 2, wherein the retainer means having both the large high friction means.

5. The connector assembly of clam 1, wherein the retainer element detachably mounted the one end portion of the female element.

6. The connector assembly of clam 1, wherein the large high friction element detachably mounted the one end portion of the female element.

7. The connector assembly of clam 1, wherein the fastener means detachably mounted the one end portion of the female element.

8. The connector assembly according to claim 1, the large high friction element is sealinglly covered the outer peripheral of the insert end portion by the fastener means when the insert end portion is fully inserted into the one end portion of the female element;

9. The connector assembly according to claim 1, the retainer element is integral with the large high friction element.

10. The connector assembly of clam 1, wherein the large high friction element is coaxially disposed to the enlarged internal bore potion together with the retainer element, and the large high friction element elasticity can be secured an axial one side portion adjacent the one opening of enlarged internal bore potion to be fastened against an outer peripheral of the axial hinder area of the smooth cylindrical portion of the insert end portion when the fastener means fasten the large high friction means by means of the fastening operation after the insert end portion is fully inserted into the one end portion of the female element.

11. The connector assembly of clam 10, wherein the fastener means is integral with the large high friction element.

12. The connector assembly of clam 1, wherein the large high friction element is coaxially disposed to the enlarged internal bore potion together with the retainer element, and the large high friction element elasticity can be secured an axial other side portion of the enlarged internal bore potion to be fastened against an outer peripheral of the axial front area of the smooth cylindrical portion of the insert end portion when the fastener means fasten the large high friction means by means of the fastening operation after the insert end portion is fully inserted into the one end portion of the female element.

13. The connector assembly of clam 12, wherein the one end portion of the female element integral with the retainer means adjacent the one opening.

14. The connector assembly of clam 1, wherein the one end portion of the female element integral with the retainer means adjacent the one opening.

15. The connector assembly according to claim 1, the large high friction element is sealinglly covered the outer peripheral of the insert end portion by the fastener means when the insert end portion is fully inserted into the one end portion of the female element.

16. The connector assembly of clam 2, wherein the large high friction element is concentricly disposed with the retainer element.

17. The connector assembly according to claim 1, wherein the retainer element having both the large high friction means.

18. The connector assembly according to claim 1, wherein the fastener means is integral with the large high friction means.

19. The connector assembly according to claim 1, wherein the one end portion providing an aperture, the aperture defining a sidewall formed in the housing in transverse communication with the enlarged diameter internal bore potion for the fastening operation of the fastener means, whereby a rotational movement between the male element and the female element is prevented by means of engaging a part of body portion of the fastener means against a sidewall of the aperture when the fastener means fastens the large high friction means against the insert end portion.
